(19) United States
(12) Patent Application Publication
(10) Pub. No.: US 2026/0205422 A1
(43) Pub. Date: Jul. 16, 2026

(54) DYNAMIC LOAD BALANCER AND HEALTH MONITOR FOR ARTIFICIAL INTELLIGENCE MODEL DEPLOYMENTS

(71) Applicant: BOLD Limited, Hamilton (BM)

(72) Inventors: Umar Afzal HAFIZ, Noida (IN); Vandana SINGH, Noida (IN); Baroon ANAND, New Delhi (IN)

(21) Appl. No.: 19/017,280

(22) Filed: Jan. 10, 2025

(51) Int. Cl. H04L 47/62; H04L 41/16; H04L 47/125

(52) U.S. Cl. CPC H04L 47/623; H04L 41/16; H04L 47/125

(57) ABSTRACT

Certain aspects of the disclosure provide a computer-implemented method for monitoring the health of artificial intelligence (AI) model deployments and provide load balancing of user requests to the AI models. The method periodically sends health-status checks to identify available AI models and unavailable AI models. The method sends request obtained from users to the available AI models that corresponds to an AI model types identified in the requests and within rate limits associated with the available AI models. The method sends answers generated by the available AI models to the users.

### BACKGROUND

### Field

Aspects of the present disclosure relate to use of artificial intelligence models.

### Description of Related Art

Innovations in various artificial intelligence (AI) technologies continue to shape the future of many different industries and emerging technologies. These industries and emerging technologies include manufacturing, managing big data, data analysis, robotics, medical imaging and diagnosis, internet of things (IoT), and generating text and images. AI technologies are implemented as AI models, where each model is a program that has been trained on a particular set of data to learn patterns, make decisions, or perform tasks without human intervention. For example, generative pre-trained transformers (GPTs) models are AI models that automate and improve a variety of tasks, such as language translation, document summarization, writing blog posts, building websites, designing visuals, making animations, writing computer code, and providing research results for complex topics.

Other types of emerging AI technologies include AI models that generate and edit images based on natural language input, AI models that are able to convert audio into text, AI models that convert text into numerical forms called “embeddings” that can, in turn, be used to measure relatedness between two pieces of text, and AI models that can detect whether text may contain sensitive or unsafe information.

In recent years, AI providers have combined various AI models into groups of AI models that may be running on different computing platforms. The platforms may be deployed in different geographical regions of the world to provide AI services to a wide range of users. Each region may provide a different group of AI models to users. Users and AI providers enter into service level agreements (SLA) that place limits on AI model usage.

However, the limits on AI model usage prevent users from scaling up AI services when the demand for AI model services is high. To complicate matters further, AI models running in different computing platforms can be down from time to time, which adversely affects operations of the users and/or services offered by the users to customers. Users who enter in SLAs with AI providers seek methods and systems that ensure consistent performance of AI models and satisfy the SLAs with AI providers.

### SUMMARY

Certain aspects provide a computer-implemented method that periodically sends health-status checks to a vendor application programming interface (API). The method obtains as output from the vendor API a health-status response identifying an available AI model. The method sends a request obtained from a user to the available AI model that corresponds to an AI model type identified in the request and is within a rate limit associated with the available AI model. The method sends an answer generated by the available AI model to the user.

Other aspects provide an apparatus comprising: a scheduler application programming interface (API) configured to periodically identify available artificial intelligence (AI) models and unavailable AI models in a group of AI models and an AI model API. The AI model API is configured to receive requests to use particular AI model types sent from a plurality of users; distribute the requests to the available AI models that correspond to the AI model types requested by the users and are within rate limits of the available AI models; and send answers generated by the available AI models to the plurality of users in response to the requests.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIGS. 1A-1E depict an example of health monitoring of artificial intelligence (AI) models deployments.

FIGS. 2A-2B depict an example of performing load balancing of user requests using weight round-robin scheduling.

FIG. 3 depicts an example architecture of an AI model application programming interface (API).

FIG. 4 depicts an example architecture of a scheduler API.

FIG. 5 depicts an example of a client models of the scheduler API.

FIG. 6 depicts an example sequence diagram of operations performed by the scheduler API, the AI model API, and a vendor API.

FIG. 7 depicts an example of an AI model API and a scheduler API performing health monitoring and load balancing of deployments of AI models of multiple AI providers.

FIG. 8 depicts a flow diagram of a method for health monitoring and load balancing requests for AI models.

FIG. 9 depicts a flow diagram of a method step in FIG. 8.

FIG. 10 depicts a flow diagram of a method step in FIG. 8.

FIG. 11 schematically depicts an example computing device according to one or more embodiments shown and described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for performing dynamic load balancing of multiple groups of AI models and health monitoring of the AI models to provide users with seamless access to available AI models, fault tolerance of unavailable AI models, and reduce the effects of limited usage and downtime of AI models.

As discussed above, AI providers combine various AI models into groups of AI models that are deployed in computational platforms. A computational platform is the infrastructure (e.g., servers, network, and data storage appliances) and software used to deploy a group of AI models. These computational platforms may be deployed in different geographical regions around the world in order to offer AI services to a wide range of users. Computational platforms may run different groups of AI models. A user can be a company, a government agency, a person, an organization that integrates AI technologies into operations of the user or provides AI-based services to customers. In some cases, AI providers enter into service level agreements (SLAs) with users. An SLA is a contract that documents which models in a group of AI models a user is permitted to use and contains limitations on AI model usage. For example, an SLA may limit the number of requests a user can submit to each AI model within a period of time. As another example, an SLA may limit the number of tokens (e.g., a token in English may range from one character to five characters) a user can submit per minute to GPT models that read and write text in tokens. Each request identifies a particular AI model and includes instructions, such as a prompt, directing the AI model to produce a desired answer or result.

However, users who entered into SLAs with AI providers to integrate AI models into internal operations and/or provide AI-based services to customers face a number of challenges.

First, the limitations on usage prevent users from being able to automatically scale up the number of requests that can be submitted to certain AI models without first sending a formal request to increase the usage limits to the AI providers. As a result, users have to wait for AI providers to approve the requests, which delays operations of the users and AI-based services provided to customers of the users.

Second, users are often frustrated by the limited number of requests (e.g., rate limit) that can be submitted per unit time to an AI model and/or by the limited number of tokens that can be submitted to an AI model per unit time. Moreover, even if a user is able to keep the number of tokens submitted to a GPT model just below the token limit of the GPT model, the number of tokens can affect how long the GPT model takes to generate an output and whether the GPT model will work at all.

Third, users are often frustrated by unexpected AI model downtime. For example, when a user is denied access to an AI model that is critical to internal operations of the user or AI-based services provided to customers because the model is unavailable, the user is forced to search for a similar available alternative AI models running in other computational platforms, which wastes time and money because the computational platforms may not provide the same groups of AI models to users.

Traditional load balancing solutions are not able to effectively scale user requests, particularly when dealing with AI models with different rate limits across multiple computational platforms.

Traditional load balancing solutions also lack the flexibility to adapt to dynamic changes in request patterns and AI model availability. With AI applications, where the demand for specific AI models may vary significantly over time, static load balancing methods are not able to increase allocation of requests to AI models and ensure consistent performance of AI models.

Ensuring high availability and fault tolerance of AI models is crucial for mission-critical applications of AI models. However, traditional load balancing solutions lack built-in mechanisms for detecting unavailable AI models, such as detecting AI models that are unavailable because the AI models are temporarily overloaded with large numbers of user requests. As a result, users may experience service disruptions, long lag times between submitting requests and receiving answers, and data loss without any knowledge of the cause.

Certain aspects described herein provide a technical solution to the above described technical problems of limited AI model usage and inconsistent availability of AI models in order to satisfy performance benchmarks (e.g., as defined by SLAs) between users and AI providers and to improve the state of the art associated with using groups of AI models.

In certain aspects, an automated dynamic load balancer periodically checks the health status of individual AI models within distributed groups of AI models (e.g., groups of AI models executing on different computational platforms located in different geographical regions) in order to identify currently available and unavailable AI models. The load balancer receives requests to use AI model types from a plurality of users and sends the requests to the available AI models that correspond to the AI model types requested by the users across the distributed groups and within the rate limits of the available AI models. Answers generated by the available AI models are sent to the respective users.

Note that the computational platforms are described herein as being distributed in different geographical regions as one example of the distribution of AI models; however this is not intended to be a limiting practical application. The computational platforms used to run the groups of AI models can be distributed in many different ways, such as distributed among different hardware and/or cloud-based service resources, distributed across departments within an organization, distributed between different locations in a single region (e.g., different cities in a state), etc.

In certain aspects, the requests are distributed to the available AI models according to a weighted round-robin schedule, thereby ensuring that the workloads associated with the requests are appropriately matched with the rate limits of the AI models.

In certain aspects, the health status of each unavailable AI model is repeatedly checked with increasing frequency to quickly detect when the AI models becomes available again. In some cases, requests can be sent to newly available AI models with the shortest possible time delay, thereby maintain the highest possible availability of AI models.

Thus aspects described herein provide a technical solution that manages request from multiple users, offers load balancing of AI models, fault tolerance of unavailable AI models, and scalability for increased performance over traditional load balancers.

### Example Methods for Health Monitoring and Load Balancing of AI Models

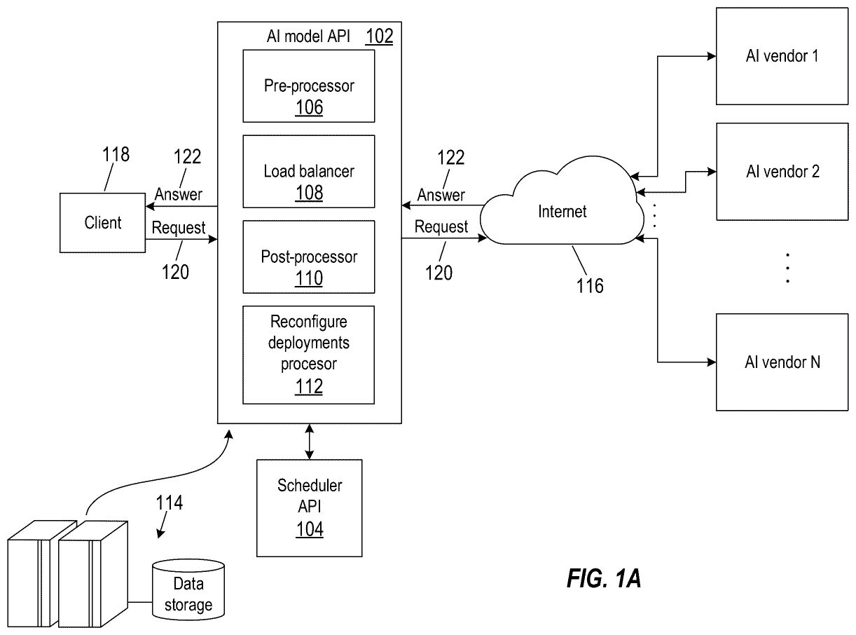

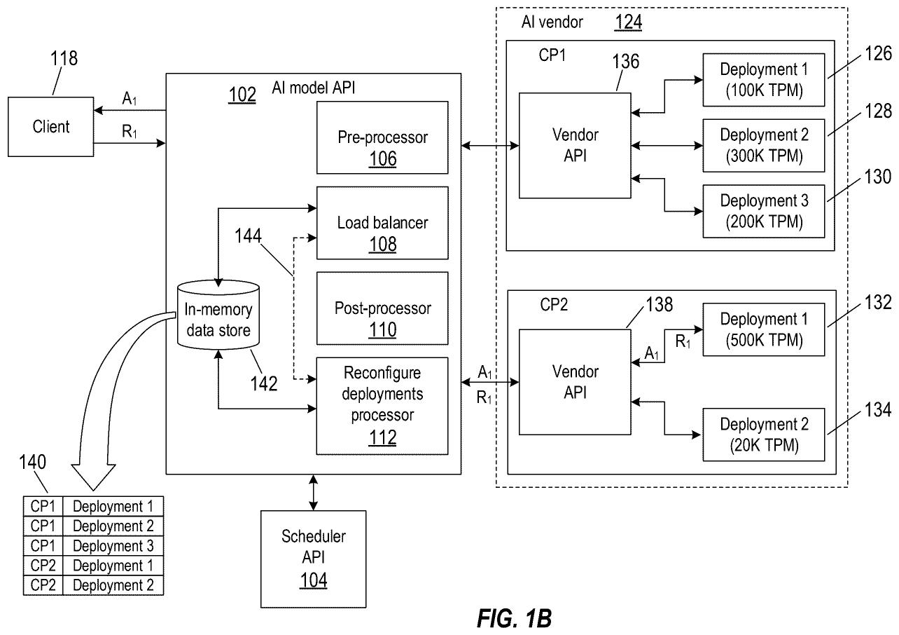

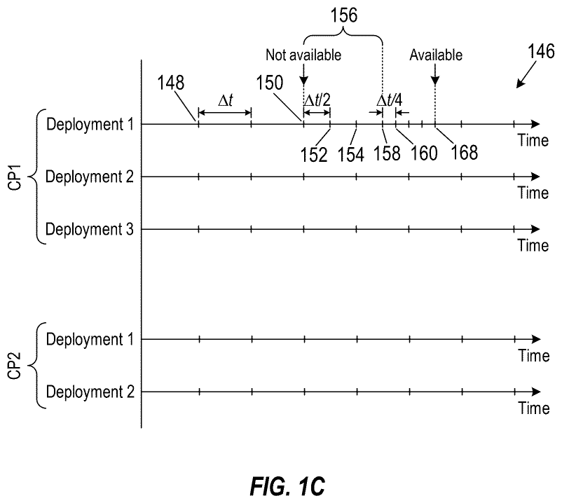

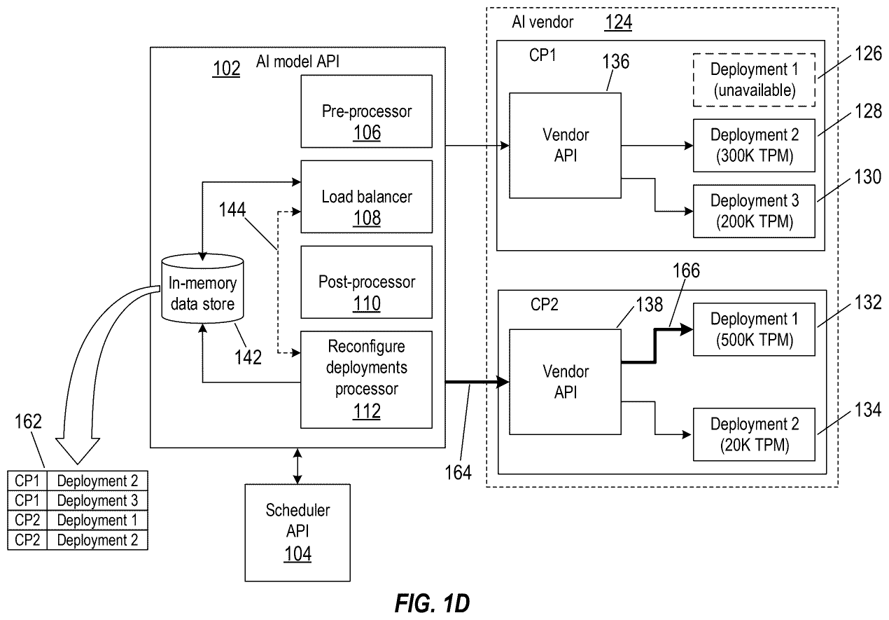

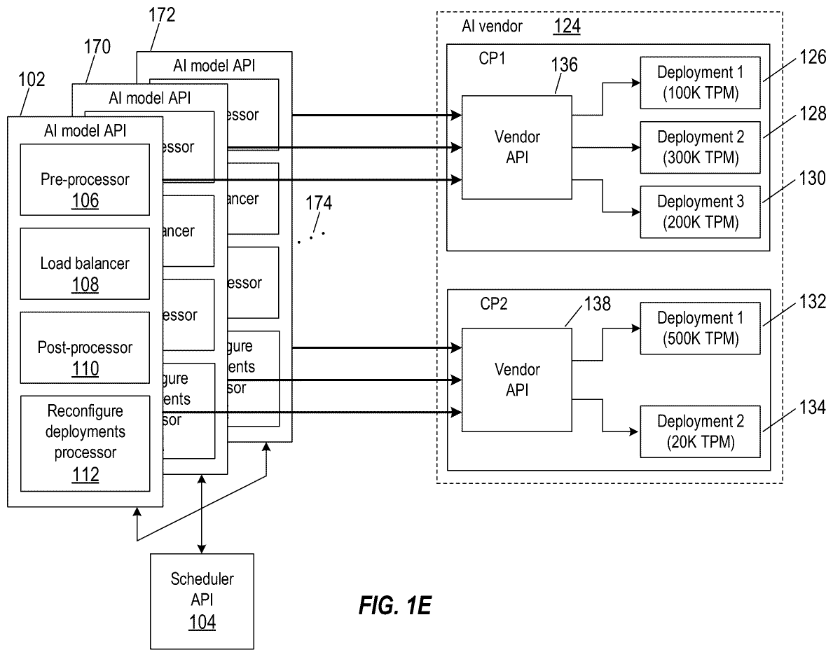

FIGS. 1A-1E depict an example of using an AI model API 102 and scheduler API 104 to perform health monitoring of AI models, identify available AI models, dynamic load balancing of user requests to available AI models, and fault tolerance of unavailable AI models. The operations performed by the AI model API 102 and the scheduler API 104 as described herein reduces the adverse effects of limits on AI model usage and downtime of unavailable AI models in order to provide users with seamless access to the available AI models.

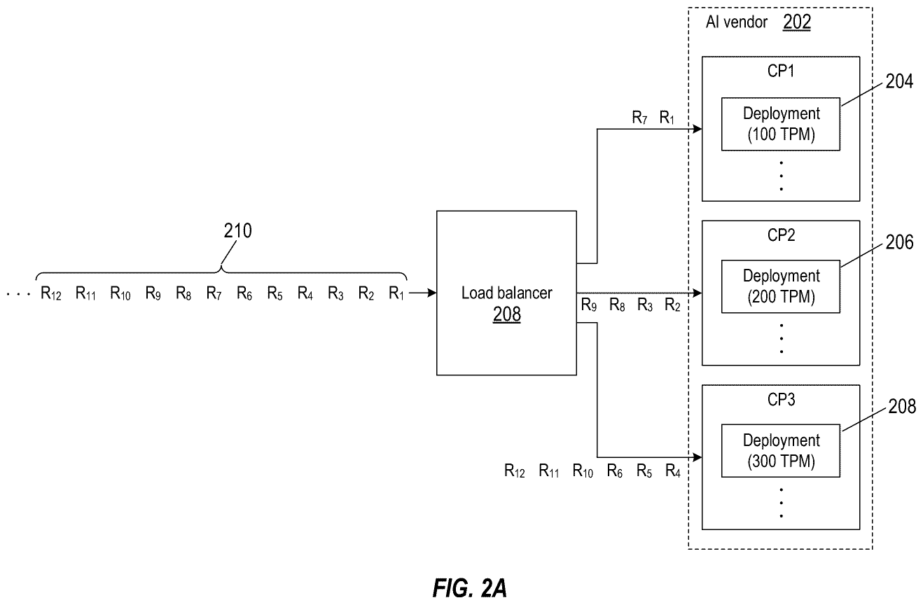

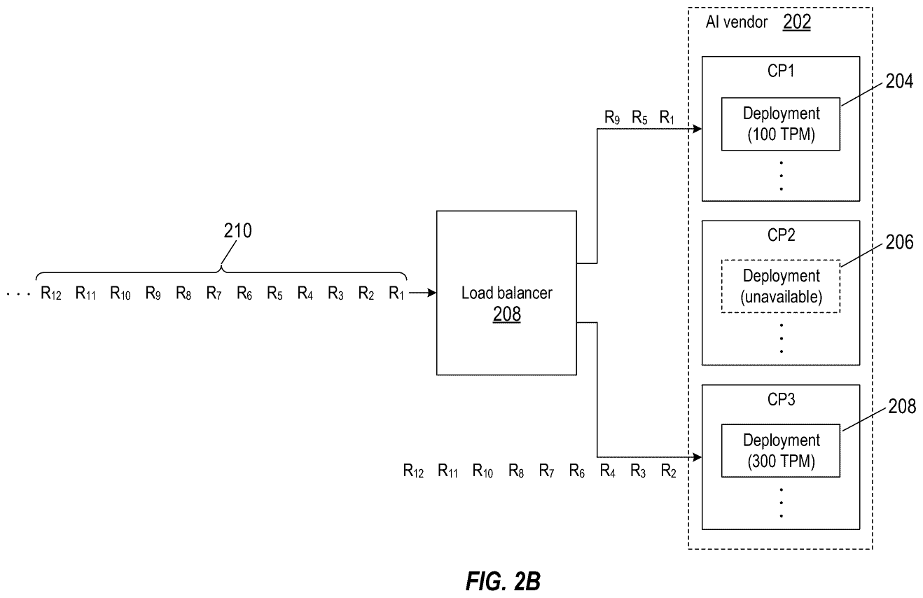

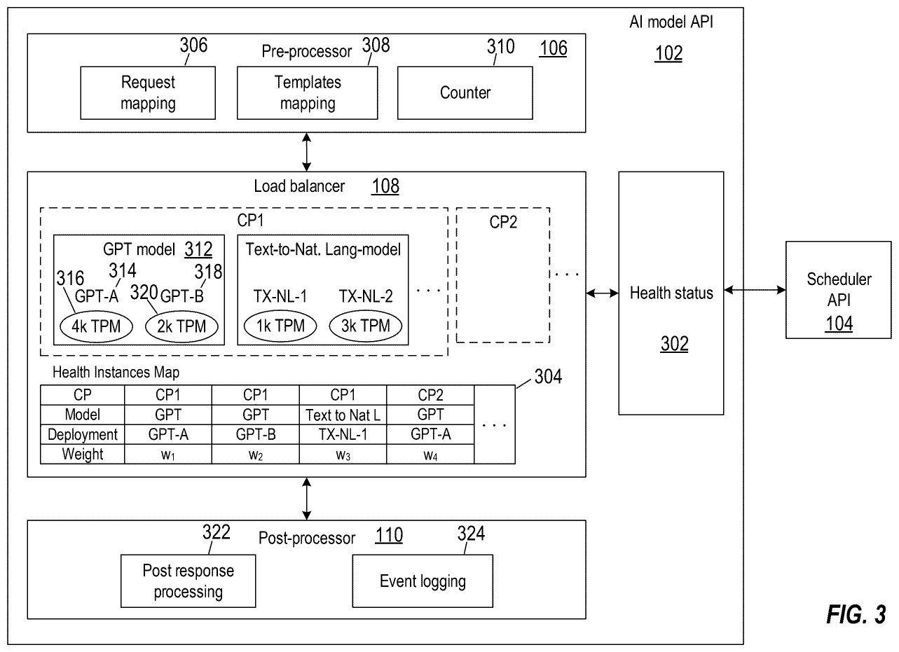

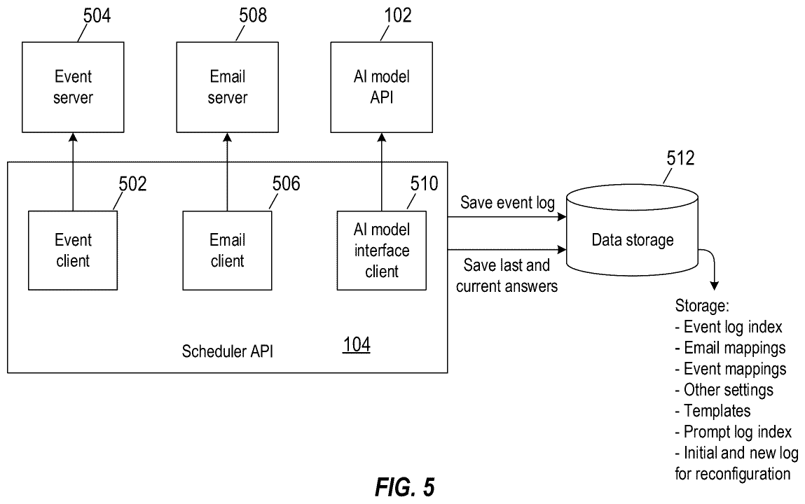

In FIG. 1A, the AI model API 102 includes a pre-processor 106 described below with reference to FIG. 3, a load balancer 108 described below with reference to FIGS. 2A, 2B, and 3, and a post-processor 110 described below with reference to FIG. 3, and a reconfigure deployments processor 112 described below with reference to FIGS. 1B and 1D. The scheduler API 104 is described below with reference to FIG. 5.

The AI model API 102 and scheduler API 104 are run on a computer system 114. The AI model API 102 receives requests to use particular types of AI models from a plurality of users via clients. The AI models (not shown) may be deployed and operated by a plurality of AI vendors denoted by AI vendor 1, AI vendor 2, and AI vendor N, where N is the number of AI vendors, as described below with reference to FIG. 1B. Each AI vendor deploys and maintains a plurality of different versions of AI models, such as GPTs, AI models that generate and edit images, AI models that convert text to spoken audio, AI models that convert spoken audio to text, and AI models that convert text to numerical forms.

A request is a message that contains instructions for executing an AI service on a particular type of AI model. For example, a request may contain a message with instructions for generating text (e.g., summarize a document, generate a memo, or generate a document in a particular writing style) using a GPT-4 AI model. Another request may contain a message with a voice recording and instructions for converting the voice recording to text using a particular speech-to-text AI model. A user can be a company, a government agency, a person, an organization that integrates AI technologies into operations of the user or provides AI-based services to customers via client. A client can be a computer, software, or an application that sends a request for an AI service to the AI model API 102 and receives an answer to the request from the AI model API 102.

The AI model API 102 may selectively distributes the requests to the available AI models of the AI vendors over the Internet 116 based on the AI model types stated in the requests and on rate limits of the available AI models, as described below with reference to FIGS. 1B-1D. The AI models generate answers to the requests. The answers from the AI models are forwarded to the AI model API 102, which sends the answers to the clients. For example, as shown in FIG. 1A, a client 118 sends a request 120 to the AI model API 102. The AI model API 102 selects a particular AI model of one of the AI vendors to process the request 120, as described below reference to FIG. 1B, and forwards the request 120 to the selected AI model. The AI model API 102 obtains (e.g., receives or fetches) an answer 122 to the request 120 from the AI vendor and forwards the answer to the client 118.

In FIG. 1B, an AI provider 124 has deployed AI models in two computing platforms denoted by CP1 and CP2. Each computing platform comprises servers, network devices, data storage and operating systems for running a group of AI models. In CP1, a group of three AI models are deployed in Deployment 1 126, Deployment 2 128, and Deployment 3 130. For example, Deployment 1 126 can run a GPT model (e.g., GPT-4 model), Deployment 2 128 can run an AI model that generates and edits images given a natural language prompt with instructions for generating or editing an image (e.g., DALL-E model), and Deployment 3 130 can run an AI model that converts text into natural sounding spoken audio (e.g., text-to-speech model). In CP2, a group of two AI models are deployed in Deployment 1 132 and Deployment 2 134.

The AI vendor 124 may locate the computing platforms in different geographical regions to provide AI services to users in the different geographical regions anywhere in the world. For example, CP1 can be deployed to provide AI services in the eastern United States (e.g., New York, New Jersey, Connecticut, Pennsylvania, Delaware, and Virginia) and CP2 can be deployed to provide AI services in eastern Canada region (e.g., Quebec and Ontario). Alternatively, the AI vendor 124 may distribute the computing platforms within the same region, such as within the same geographical region, state, province, city, or building. The AI vendor 124 may distribute the computing platforms with different cloud service providers.

In this example, the AI vendor 124 has deployed the same AI models on different computing platforms with different rate limits. For example, Deployment 1 126 and Deployment 1 132 are deployments of the same AI model (e.g., GPT-4) in CP1 and CP2, respectively, but with different rate limits indicated in parentheses. Rate limits can be measured in, for example, requests per minute (RPM), requests per day (RPD), tokens per minute (TPM), tokens per day (TPD), and images per minute (IPM). In the following discussion, the rate limits are in units of TPM, but other aspects may use other types of rate limits. For example, Deployment 1 126 has a rate limit of 100 K TPM and Deployment 1 132 has a rate limit of 500 K TPM. Deployment 2 128 and Deployment 2 134 are deployments of the same AI model (e.g., text-to-speech model) in corresponding CP1 and CP2, but with different rate limits.

Generally, AI providers may set rate limits primarily for the following three reasons:

First, rate limits can protect against abuse or misuse of the AI models. For example, a malicious actor may attempt to flood an AI model with an excessively large number requests (e.g., a denial of service attack) in an attempt to overload the AI model or otherwise cause disruptions in AI services. By setting rate limits, such denial of service attacks can be avoided.

Second, rate limits help to ensure that users have fair access to the AI models. If a user submits a large number of requests, certain AI models can be become overloaded. To avoid large numbers of requests sent from a single user, the vendor API can throttle the number of requests the user can submit to an AI model, thereby ensuring that the AI model is available to a large number of users.

Third, the rate limits may help to manage the aggregated workloads created by numerous requests from multiple users on the computational resources of the AI models. For example, when the number of requests sent by multiple users to an AI model increases, the servers, network, and data storage appliance used to run the AI model become overloaded and the AI models start to lag or stop running.

In FIG. 1B, each computing platform has a corresponding vendor API that exchanges information between the AI model API 102 and the deployments in the computing platform. For example, CP1 has a vendor API 136 that exchanges information between the AI model API 102 and the three deployments: Deployment 1 126, Deployment 2 128, and Deployment 3 140. CP2 has a vendor API 138 that exchanges information between the AI model API 102 and the two deployments: Deployment 1 132 and Deployment 2 134.

The reconfigure deployments processor 112 maintains a table of available (e.g., up, active, or running) deployments at the computing platforms. In one aspect, the reconfigure deployments processor 112 maintains an available deployments table 140 in an in-memory data store 142. In this example, the available deployments table 140 contains a list of all available deployments (e.g., available AI models) of the AI vendor 124. As described above, the AI model API 102 receives requests to use particular types of AI models from multiple users via clients. In one aspect, the load balancer 108 reads the available deployments table 140 in the in-memory data store 142. In another aspect, the load balancer 108 submits a query to the reconfigure deployments processor 112, which fetches the available deployments table 140 from the in-memory data store 142, enabling the load balancer 108 access to the available deployments table 140 as indicated directional arrow 144. The load balancer 108 uses the available deployments table 140 to distribute the requests to the available AI models that correspond to the AI model types stated in the requests and are within rate limits of the available AI models via the vendor APIs. The AI models generate answers to the requests. The vendor APIs receive the answers from the corresponding AI models and forward the answers to the AI model API 102, which sends the answers to the clients.

In FIG. 1B, for example, the client 118 sends a request denoted by R₁ to the AI model API 102. Suppose, for example, the request R₁ contains instructions for using the type of AI model at Deployment 1 126 and Deployment 1 132. The load balancer 108 checks the available deployments table 140 to confirm that both Deployment 1 126 and Deployment 1 132 are available and uses a weighted round-robin schedule to determine whether to send the request R₁ to Deployment 1 126 or to Deployment 1 132 as described below with reference to FIGS. 2A-2B. Suppose, for example, the load balancer 108 has selected Deployment 1 132 to generate an answer A₁ to the request R₁. The load balancer 108 forwards the request R₁ to the vendor API 138, which forwards the request R₁ to Deployment 1 132 for processing. The vendor API 138 fetches, or receives, the answer A₁ generated by Deployment 1 132 and forwards the answer A₁ to the AI model API 102, which forwards the answer A₁ to the client 118.

The AI model API 102 and scheduler API 104 provide fault tolerance by monitoring the health of deployments for unavailable AI models (e.g., down or overloaded AI models) and divert requests away from the unavailable deployments by sending the requests to available AI models with the same types of AI model in the requests. The scheduler API 104 performs periodic health monitoring of the AI models by sending a load-balancer request to the AI model API 102 at the end of regularly spaced time intervals. For example, the load-balancer request may identity of a particular model to use, a prompt, and prompt properties, such as temperature and top probability. The AI model API 102 responds to the load-balancer request by sending a health-status check to the vendor APIs 136 and 138. For example, the health-status check may be a prompt that contains a questions, such as “can I ask you a question?” The vendor API 136 sends the health-status check to Deployment 1 126, Deployment 2 128, and Deployment 3 130. The vendor API 138 sends the health-status check to Deployment 1 132 and Deployment 2 134. Each deployment sends a health-status response indicating the health of the deployment and/or the health of the computational resources running the deployment to the corresponding vendor API in response to receiving the health-status check.

In certain aspects, the health-status response may be a hypertext transfer protocol (HTTP) status code. For example, the health-status response may be an HTTP status code 200 that indicates there are no performance problems at the deployment, an HTTP status code 429 indicating the AI model of the deployment is overloaded with requests, or an HTTP status code 503 indicating the server (e.g., CPU or memory) running the AI model is overloaded. The vendor API 138 collects the health-status responses from the deployments and sends a load-balancer response to the AI model API 102. The vendor API 136 also sends a load-balancer response to the AI model API 102. Each load-balancer response contains one or more status codes for corresponding deployments. The reconfigure deployments processor 112 updates the available deployments table based on the load-balancer response. Only deployments with HTTP status code 200 are added to the available deployments table.

FIG. 1C depicts an example plot 146 of time axes associated with each of the deployments in CP1 and CP2. Marks located along the time axes, such as mark 148, represent times when the scheduler API 104 sends a load-balancer request causing the AI model API 102 to send health-status checks to the vendor AIs. In this example, the times are separated in regularly spaced time intervals of duration, Δt, between health-status checks sent to Deployment 2 and Deployment 3 of CP1 and Deployment 1 and Deployment 2 of CP2 because the deployments return the HTTP status code 200 to corresponding vendor APIs after each health-status check. The duration of the time interval, t between periodic health-status checks is set to a fixed time increment. For example, the duration may be set to 1 minute, 5 minutes, 10 minutes, 15 minutes, 20 minutes, 30 minutes, 45 minutes, or one hour.

By contrast, Deployment 1 in CP1 experiences a performance issue at time 150. For example, the Deployment 1 may return the HTTP status code 429 or the HTTP status code 503 to the vendor API 136, which forwards the status code to the AI model API 102. The scheduler API 104 also receives the status code and shortens the duration of the time interval between sending health-status checks to Deployment 1. For example, the scheduler API 104 may shorten the duration of the time interval between sending status checks to Δt/2 as indicated at time points 152 and 154. If the Deployment 1 remains offline, after a period of time 156, the scheduler API 104 may further shorten the duration of the time interval between sending status checks to Δt/4 as indicated times 158 and 160.

In FIG. 1D, the reconfigure deployments processor 112 recreates an available deployments table 162 based on the load-balancer response. Only deployments with HTTP status code 200 are added to the available deployments table 162. In this example, the available deployments table 162 does not include unavailable Deployment 1 126. While Deployment 1 126 is offline, the load balancer 108 sends requests that may have been sent to the AI model in Deployment 1 126 to Deployment 1 132 as indicated by directional arrows 164 and 166.

Returning to FIG. 1C, at time 168, Deployment 1 126 returns an HTTP status code 200, indicating the AI model associated with Deployment 1 126 is available. The reconfigure deployments processor 112 recreates an available deployments table with the Deployment 1 132 added. As a result, the load balancer 108 resumes sending requests to Deployment 1 126 and Deployment 1 132 in accordance with weighed round-robin scheduling as described above with reference to FIG. 1B.

In certain aspects, multiple AI model APIs can send requests to deployments of the same AI vendor. FIG. 1E depits an example of multiple AI model APIs in communication with vendor APIs 136 and 138 of the AI vendor 124. In this example, AI model APIs 170 and 172 are configured and operate in the same manner as the AI model API 102 describe herein. Ellipses 174 represent additional AI model APIs that are not shown for the sake of convenience.

For the sake of simplicity, methods for monitoring the health status of deployments are not limited to monitoring the health status of deployments to two geographical regions. In practice, methods described above can be extended to monitoring the health of any number of deployments in any number of geographical regions. Further, as described above, monitoring of distributed AI model deployments need not be in different geographical regions. Rather, the deployments need only be logically partitioned (e.g., by computing platforms) in such a way that the deployments are treated as separate by methods and systems described herein.

### Weighted Round-Robin Scheduling of Requests

FIGS. 2A-2B depict an example of load balancing performed by the load balancer 108 of the AI model API 102 using weighted round-robin scheduling. The load balancer 108 performs weighted round-robin scheduling based on the rate limits of the deployments. In FIG. 2A, an AI provider 202 has deployed the same type of AI model in deployments 204, 206, and 208 in three computing platforms denoted by CP1, CP2, and CP3, respectively. For the sake of simplicity of illustration, the AI model API 102 and vendor APIs of the computing platforms are not shown. The deployments 204, 206, and 208 have different rate limits. The rate limit of the deployment 204 is 100 TPM. The rate limit of the deployment 206 is 200 TPM. The rate limit of the deployment 208 is 300 TPM. The load balancer 108 distributes requests to the AI model associated with the three deployments using weighted round-robin scheduling based on the rate limits of the deployments 204, 206, and 208.

In certain aspects, weighted round-robin scheduling is performed by determining a weight for each of the deployments 204, 206, and 208. A weight corresponds to the number of requests sent to a deployment. For example, a weight may correspond to the maximum number of requests that are allowed by a vendor to be sent to a particular model. In one aspect, the weights of the deployments 204, 206, and 208 may be determined by dividing the rate limits of the deployments by the smallest rate limit of the three deployments. In the example of FIG. 2A, the deployment 204 has the smallest rate limit of 100 K TPM. The weight associated with the deployment 204 is w₁=1 (e.g., w₁=100/100=1). The weight associated with the deployment 206 is w₂=2 (e.g., w₂=200/100=2). The weight associated with the deployment 208 is w₃=3 (e.g., w₃=300/100=3).

In another aspect, the weights associated with the deployments may be assigned or set prior by a systems administrator or an infrastructure team, such as at the time of model deployment. For example, the weight assigned to the deployment 204 may be set to 1 (e.g., w₁=1). The weight assigned to the deployment 206 may be set to 2 (e.g., w₂=2). The weight assigned to the deployment 208 may be set to 1 (e.g., w₃=3). In this aspect, the weights can only be changed by the systems administrator or the infrastructure team.

Weighted round-robin scheduling can be executed in cycles of requests for the same type of AI model. The number of requests in each cycle is the sum of the weights. For example, the number of requests in each cycle associated with the deployments 204, 206, and 208 is six (e.g., w₁+w₂+w₃). The weights correspond to the number of request sent to the corresponding deployment.

In FIG. 2A, twelve requests 210 sent to the load balancer 108 are denoted by Rᵢ, where i=1, . . . , 12 represents the order in which the request are received at the AI model API 102 (not shown). Each of the requests identifies the same AI model associated with the deployments 204, 206, and 208. In a first cycle, the load balancer 108 sends the first request R₁ to the deployment 204 (w₁=1), sends the next two requests R₂ and R₃ to the deployment 206 (w₂=2), and sends the next three requests R₄, R₅ and R₆ to the deployment 208 (w₃=3). In a second cycle, the next six requests for the AI model are distributed in the same manner. The load balancer 108 sends the seventh request R₇ to the deployment 204, sends the next two requests R₈ and R₉ to the deployment 206, and sends the next three requests R₁₀, R₁₁ and R₁₂ to the deployment 208.

In the event that one of the deployments 204, 206, and 208 is not available as described above with reference to FIGS. 1B-1C, the weights are recalculated for the two remaining deployments and the requests are distributed according to the new weights.

In FIG. 2B, deployment 206 is offline. For example, the AI model associated with deployment 206 may be overloaded by requests from multiple user and/or the computational resources that run the AI model are overloaded. In this example, the load balancer 108 sends the requests in cycles of w₁+w₃ requests. In the first cycle, the load balancer 108 sends the first request R₁ to the deployment 204 and sends the next three requests R₂, R₃ and R₄ to the deployment 208. In the second cycle, the next four requests for the AI model are distributed in the same manner. The load balancer 108 sends the fifth request R₅ to the deployment 204 and sends the next three requests R₆, R₇, and R₈ to the deployment 208. In the third cycle, the load balancer 108 sends the ninth request R₉ to the deployment 204 and sends the next three requests R₁₀, R₁₁, and R₁₂ to the deployment 208.

### Example Architecture of an AI Model API

FIG. 3 depicts an example architecture of the AI model API 102. The AI model API 102 includes a health status block 302. The health status block 302 receives the load-balancer request from the scheduler API 104 at the end of regularly spaced time intervals as described above with reference to FIG. 1B. The health status block 302 sends health-status checks to the vendor APIs at the ends of regularly spaced time intervals as described above with reference to FIGS. 1A-1B. The health status block 302 maintains a health instances map 304 that is used by the load balancer 108, enabling the load balancer 108 to execute weighted round-robin scheduling of requests as described above with reference to FIGS. 2A-2B.

FIG. 3 depicts an example representation of the health instances map 304 as a table with entries for different computing platforms, AI models, deployments, and weights. The health instances map 304 is stored in the in-memory data store 142 in FIGS. 1B and 1D. The AI models listed in the health instances map 304 are currently available based on the HTTP status code 200 having been received from the deployments as described above with reference to FIGS. 1A-1B. When a deployment returns the HTTP status code 429 or the HTTP status code 503, as described above with reference to FIGS. 1B-1C, the health status block 302 deletes the deployment from the health instances map 304, thereby making the deployment unavailable (e.g., offline) to the load balancer 108. The scheduler API 104 decreases the duration between health-status checks sent to the offline deployment, as described above with reference to FIG. 1B, until the deployment returns the HTTP status code 200. When the unavailable deployment returns the HTTP status code 200, the health status block 302 writes the deployment to the health instances map 304, thereby making the deployment available (e.g., online) to the load balancer 108 for weighted round-robin scheduling described above. The pre-processor 106 preprocesses requests that are received from users. The pre-processor 106 includes a request mapping block 306, a template mapping block 308, and a counters block 310. The pre-processor 106 checks the contents of each request. For example, the pre-processor 106 may check if a request contains any code and remove XML nodes. The request mapping block 306 maintains a mapping of AI models with deployments available to the load balancer 108 for the computing platforms of the AI provider. The mapping is configurable without the need for redeployment when a new AI model is added. The counters block 310 stores information regarding the number of tokens that are used for each model and may be used to determine the load sent to each model.

The load balancer 108 sends requests to available deployments based on the weighted round-robin schedule described above with reference to FIGS. 2A-2B. In FIG. 3, the load balancer 108 contains a record of the deployments and corresponding rate limits for each computing platforms of the AI provider. For CP1, the load balancer 108 contains a record of GPT models 312 with deployment GPT-A 314 and a corresponding rate limit 316 and deployment GPT-B 318 and a corresponding rate limit 320. The load balancer 108 calculates the weights in the health instances map 304 as described above with reference to FIGS. 2A-2B. The post-processor 110 includes a post response processing block 322 and an event logging block 324. The post response processing block 322 sends the answers generated by the deployment to the users. The event logging block 324 records events and associated time stamps of the processes executed by the pre-processor 106 and the load balancer 108 in an event log. Event logging block 324 store the historical data for audit logs and analysis.

### Example Architecture of a Scheduler API

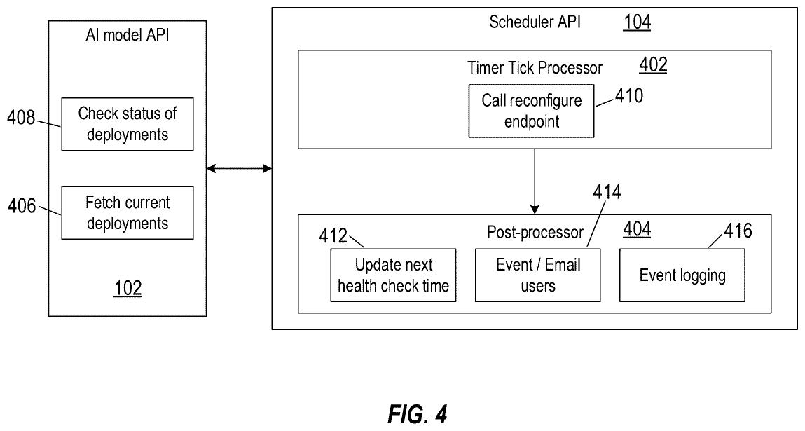

FIG. 4 depicts an example architecture of the scheduler API 104. The scheduler API 104 includes a time tick processor 402 and a post-processor 404. The AI model API 102 includes a fetch current deployments block 406 that fetches a list of deployments from the in-memory data store 142 and a check status of deployments block 408 that sends health-status checks to each of the deployments identified in the list of deployments. If any of the deployments are unavailable as described above, then the check status of deployments block 408 decreases the duration of the time interval between health-status checks sent to each unavailable deployment as described above with reference to FIG. 1B. The time tick processor 402 includes a call reconfigure endpoint block 410. The call reconfigure endpoint block 410 calls the reconfigure deployments processor 112 in FIG. 1D to reconfigure endpoints (e.g., URLs) of the deployments based on any changes to the locations of the deployments. The post-processor 404 includes an update next health check time block 412, an event/email users block 414, and an event logging block 416. The update next health check time block 412 sets times for the frequency of status checks (e.g., decreases the duration of the time interval between time status checks) sent to deployments as described above with reference to FIG. 1B. When a deployment has returned to a normal or available status (e.g., the status code 200), the update next health check time block 412 resets the duration of the time interval between health-status checks to the regular time interval for the deployment. The event logging 418 logs events for audit logging.

The event/email users block 414 uses an event service and an email service to send messages that describe events to users and subscribers. For example, event logging block 416 sends email messages that report the current available/unavailable status of deployments in the computing platforms of the AI provider to the users and subscribers to keep users and subscribers informed as to which models are unavailable.

The event logging block 416 records events and associated time stamps of processes or actions executed by the time tick processor 402 and the post-processor 404 in an event log. Events include I/O events, API requests, user requests, active and inactive status of deployments, and status of computational resources.

FIG. 5 depicts an example of a client-server model of the scheduler API 104. The scheduler API 104 includes automated clients 502, 506, and 510. Each client is a microservice API. For example, the event client 502 is an API that automatically sends messages that describe events occurring with the models to an event server 504. The event server 504 sends the messages to subscribers of the service provided by the AI model API 102. The email client 506 is an API that automatically sends messages that describe events occurring with the models to an email server 508. The email message contains a description of the current status of the deployments used to execute the user's requests. The email server 508 sends the email messages to all users of the AI model API 102. The scheduler API 104 includes an AI model interface client 510 that interfaces with the AI model API 102. For example, the AI model interface client 510 receives load-balancer requests from the AI model API 102 and sends load-balancer responses to the AI model API 102. The scheduler API 104 maintains an event log in a data storage appliance 512. The data storage appliance 512 stores email mappings (e.g., email addresses of users), event mapping (e.g., a chart of the events), other settings, templates, prompt log index, and initial and new log for recognition.

### Example Sequence Diagram of Operations by a Scheduler API, a AI model API, and a Vendor API

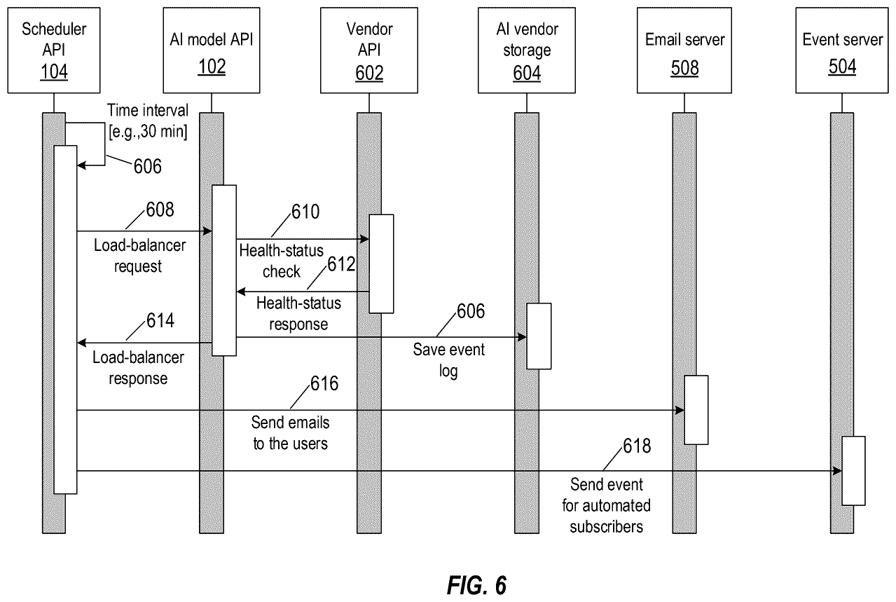

FIG. 6 depicts an example sequence diagram of operations performed by the scheduler API 104, the AI model API 102, and a vendor API 602 to schedule a job for processing a request. At the end of regularly spaced time intervals 606, the scheduler API 104 sends a load-balancer request 608 to the AI model API 102.

The AI model API 102 responds to the load-balancer request 608 by sending a health-status check to the vendor API 602 associated with deployments in a computing platform.

The vendor API 602 receives HTTP status codes from each of the deployments and sends a health-status response 612 to the AI model API 202.

The health-status response 612 may contain the status codes of the deployments in the computing platform.

The AI model API 102 saves events associated with deployments in an event log stored in an AI provider storage device 604. The storage device 604 stores status of each model and AI vendor. The storage device 604 may also be used to store information about when to perform health status checks on the model deployments.

The AI model API 102 sends a load-balancer response 614 that identifies the available and unavailable deployments in the computing platform.

The scheduler API 104 causes the email server 508 to send emails informing the users (e.g., registered users) 616 of the status of the deployments identified in their corresponding requests. The event server 504 sends a description of events to subscribers of the service provided by the AI model API 102.

The scheduler API 104 causes the event server 504 to send events to automated subscribers 618.

### Example of Health Monitoring and Load Balancing Deployments of Multiple AI Providers

The AI model API 102 and the scheduler API 104 are not limited to load balancing requests for a single AI provider as described above. In certain aspects, the AI model API 102 and the scheduler API 104 can control load balancing of requests and health monitoring of multiple deployments for multiple AI providers.

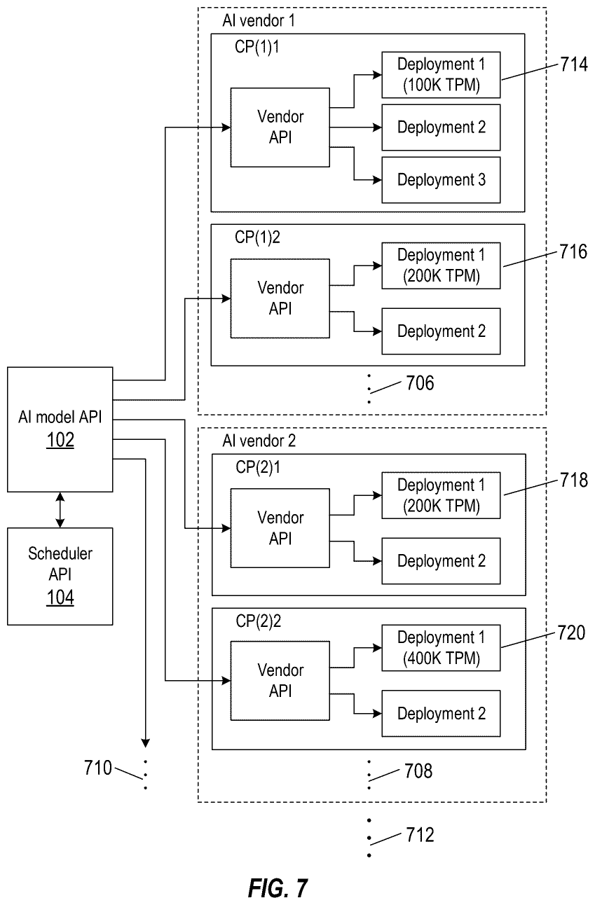

FIG. 7 depicts an example of the AI model API 102 and the scheduler API 104 performing health monitoring and load balancing of deployments of multiple AI providers. Two example computing platforms of the first AI provider 1 are denoted by CP(1 )1 and CP(1)2. Two example computing platforms of the second AI provider 2 are denoted by CP(2)1 and CP(2)2. The computing platforms can be located in different geographical regions or in the same geographical region. Each vendor API is connected to at least one deployment of an AI model. Ellipses 706, 708, 710, and 712 represent different computing platforms, vendor APIs associated with each of the computing platforms, and deployments in each computing platform, respectively, that are not shown for the sake of convenience. The scheduler API 104 sends a load-balancer request that causes the AI model API 202 to health-status checks to each of the vendor APIs in each of the computing platforms of the multiple AI providers.

The AI model API 102 executes weighted round-robin scheduling for distributing requests to deployments with the same AI model as described above with reference to FIGS. 2A-2B regardless of the AI provider. For example, Deployment 1 714, Deployment 1 716, Deployment 1 718, and Deployment 1 720 are associated with the same type of a AI model (e.g., GPT-4) but with different rate limits denoted in parentheses. Dividing each of the rate limits by the smallest rate limit (e.g., min{100, 200, 200, 400}) gives Deployment 1 714 a weight of w₁=1, Deployment 1 716 a weight of w₂=2, Deployment 1 718 a weight of w₃=2, and Deployment 1 720 a weight of w₄=4. In each cycle of nine requests for the AI model, Deployment 1 714 receives one request, Deployment 1 716 receives two requests, Deployment 1 718 receives two requests, and Deployment 1 720 receives four requests. The cycle is repeated for the next nine requests for the same AI model.

### Example Methods for Health Monitoring and Load Balancing of AI Models

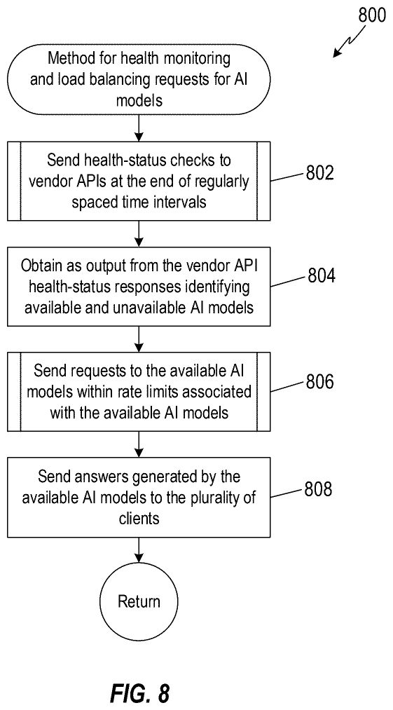

FIG. 8 depicts a flow diagram of a method 800 for health monitoring and load balancing requests for AI models of an AI vendor.

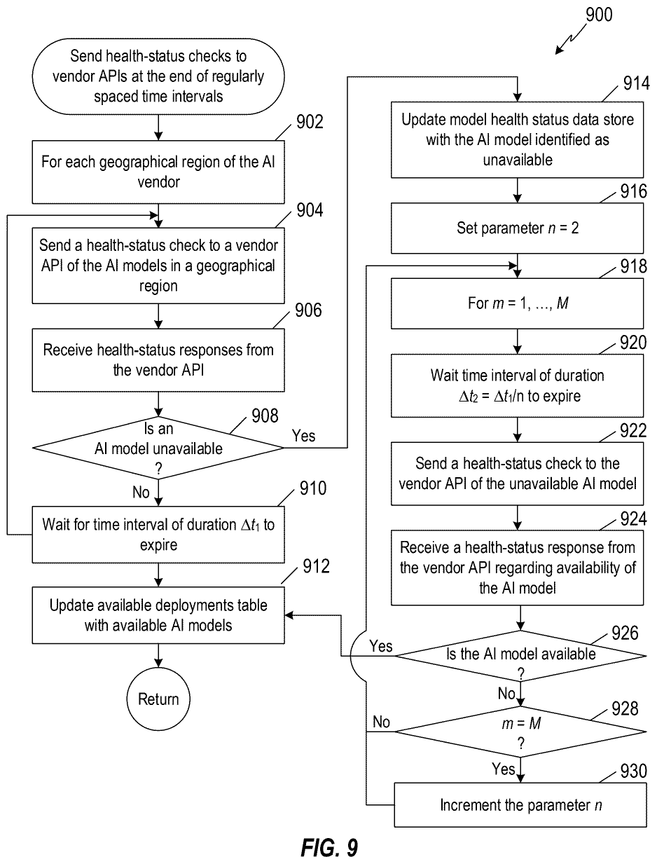

In block 802, “send health-status checks to vendor APIs at the end of regularly spaced time intervals” process is performed. An example implementation of this process is described below with reference to FIG. 9.

In block 804, health-status responses are obtained as output from vendor APIs of the AI vendor as described above with reference to FIGS. 1B-1D and 6. The health-status responses identify available and unavailable AI models as described above with reference to FIGS. 1B-1D and 6.

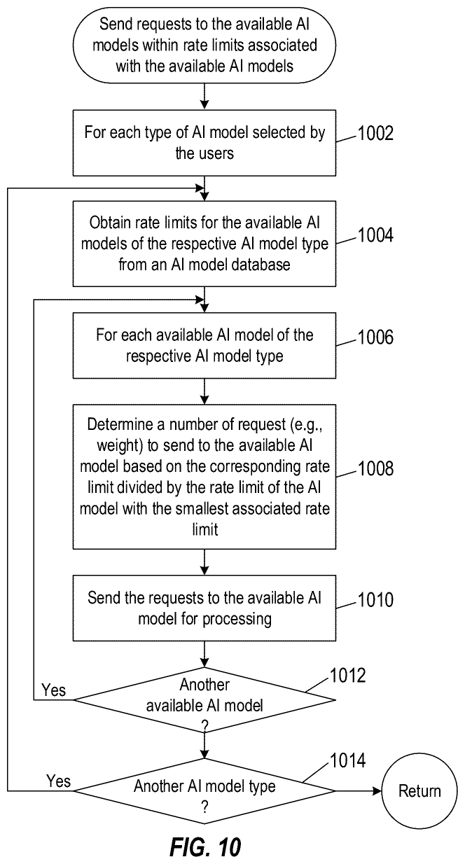

In block 806, a “send requests to the available AI models within rate limits associated with the available AI models” process is performed. An example implementation of this process is described below with reference to FIG. 10.

In block 808, answers generated by the available AI models are sent to the plurality of clients as described above with reference to FIG. 1A.

The method 800 provides fault tolerance of unavailable AI models by periodically performing health status checks of the deployments in block 802 and sending requests to the available AI models within the rate limits of the available AI models in block 806. The method 800 ensures high availability, reliability, and performance of available AI models for handling client requests. The method 800 ensures that users do not have to search for available AI models to support AI dependent operations or AI-based services provided to customers.

Note that FIG. 8 is just one example of a method, and other methods including fewer, additional, or alternative steps are possible consistent with this disclosure.

FIG. 9 depicts a flow diagram of a method 900 represented by block 802 of FIG. 8.

A loop beginning with block 902 repeats the operations represented by blocks 904 and 1006 for each computing platform.

In block 904, a health-status check is sent to a vendor API of the AI models in a computing platform as described above with reference to FIGS. 1B-1C and 6.

In block 906, health-status responses are received from the vendor API as described above with reference to FIGS. 1B-1C and 6.

In block 908, if an AI model is unavailable, control flow to block 914. Otherwise, control flow to block 910.

In block 910, wait for time interval of duration Δt1 to expire and return control to block 904 for next time interval as described above with reference to FIGS. 1B-1D.

In block 912, the available AI models are used to update an available deployments table stored in an in-memory data store as described above with reference to FIGS. 1B and 1D.

In block 914, a model health status data store is updated with the AI model identified as unavailable in block 908.

In block 916, a parameter n is set equal to 2 as described above with reference to FIG. 1B.

A loop beginning with block 918 repeats the operations represented by blocks 920, 922, 924, and 926 until the index m equals M in block 926.

In block 920, wait for time interval of duration Δt₂=Δt₁/n to expire as described above with reference to FIG. 1C.

In block 922, a health-status check is sent to the vendor API of the unavailable AI model as described above with reference to FIG. 1C.

In block 924, a health-status response is received from the vendor API regarding availability of the AI model as described above with reference to FIGS. 1C and 6.

In block 926, if the AI model is available, control flows to block 912. Otherwise, control flows to block 928.

In block 928, if the index m equals M, control flows to block 930. Otherwise, control flows to block 918.

By decreasing the duration time between health-status checks of an unavailable AI model in blocks 918, 920, 924, and 926, the method 900 is able to rapidly detect when any of the unavailable AI models become available and ensure that previously unavaible AI models are available to receive requests. The method 900 provides the technical advantage of ensuring that the amount of time between when an AI model transitions from unavailable status (e.g., overloaded) to available status (e.g., no longer overload) is minimized. In other words, when previously unavailable AI models become available these models do not sit idle and can be immediately placed into service, thereby avoiding prolonged periods of downtime.

Note that FIG. 9 is just one example of a process flow, and other methods including fewer, additional, or alternative steps are possible consistent with this disclosure.

FIG. 10 depicts a flow diagram of a method 1000 represented by block 806 of FIG. 8.

A loop beginning with block 1002 repeats the operations represented by blocks 1004, 1006, 1008, and 1010, and 1012 for each type of AI model selected by the users.

In block 1004, obtain rate limits for the available AI models of the respective AI model type from an AI model database as described above with reference to FIGS. 2A-2B.

A loop beginning with block 1006 repeats the operations represented by blocks 1008, 1010, and 1012 for each available AI model of the respective type of AI model.

In block 1008, determine a number of request (e.g., weight) to send to the available AI model based on the corresponding rate limit divided by the rate limit of the AI model with the smallest associated rate limit as described above with reference to FIGS. 2A-2B.

In block 1010, the requests are sent to the available AI model for processing.

In block 1012, the operations represented by blocks 1006 and 1008 are repeated for another available AI model.

In block 1014, the operations represented by blocks 1004, 1006, 1008, 1010, and 1012 are repeated for another type of AI model.

Note that FIG. 10 is just one example of a process flow, and other methods including fewer, additional, or alternative steps are possible consistent with this disclosure.

### Example Computing Device

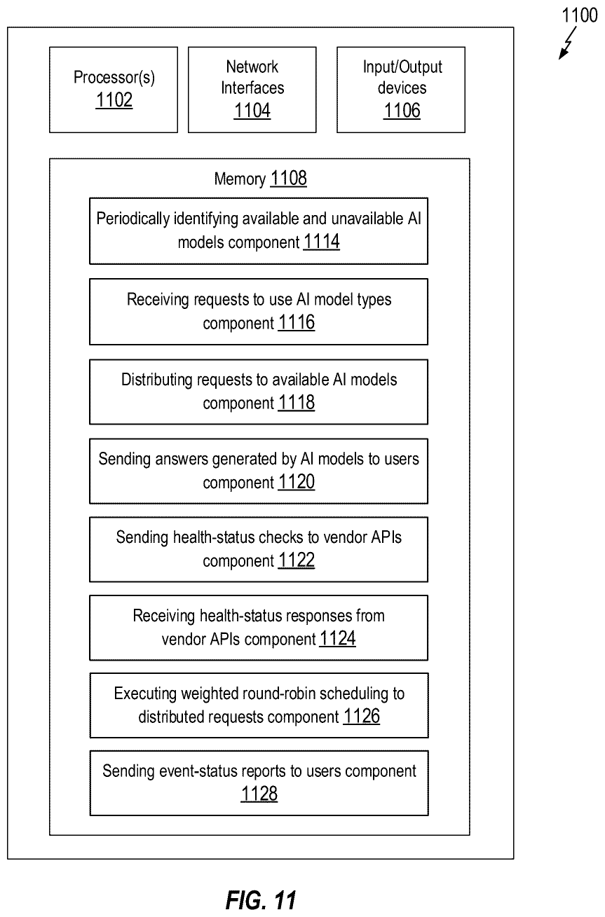

FIG. 11 schematically depicts an example computing device 1100, according to one or more embodiments shown and described herein. As illustrated, the computing device 1100 includes one or more processors 1102, one or more network interfaces 1104, input/output devices 1106, and one or more memories 1108.

Generally, processor(s) 1102 are configured to execute computer-executable instructions (e.g., software code) to perform various functions, as described herein.

The network interface(s) 1104 generally provides data access to any sort of data network, including personal area networks (PANs), local area networks (LANs), wide area networks (WANs), the Internet, and the like.

The input(s) and output(s) 1106 generally provide means for providing data to and from the online document creation system parallel interaction user interface system, such as via connection to computing device peripherals, including user interface peripherals.

The memory 1108 is configured to store various types of components and data.

In this example, memory 1108 includes a periodically identifying available and unavailable AI models component 1114, a receiving requests to use AI model types component 1116, a distributing requests to available AI models component 1118, sending answers generated by AI models to users component 1220, sending health-status checks to vendor APIs component 1122, receiving health-status responses from vendor APIs component 1124, executing weighted round-robin to distributed requests component 1126, and sending event-status reports to users component 1128.

Periodically identifying available and unavailable AI models component 1214 is configured to check the health status of individual AI models running in computing platform of an AI provider as described above with reference to FIGS. 1A-1C and FIG. 6.

Receiving requests to use AI model types component 1116 is configured to requests sent by users. Each request identifies a particular AI model and instructions, such as a prompt, directing the AI model to produce a desire answer or result.

Distributing requests to available AI models component 1118 is configured to send the request to the available deployments in the computing platforms as described above with reference to FIGS. 1A-1C and FIGS. 2A-2B.

Sending answers generated by the AI models to users component 1120 is configured to send answers generated by the AI models identified in the requests to the users as described above with reference to FIGS. 1A-1C and FIG. 6.

Sending health-status checks to vendor APIs component 1122 is configured to cause the AI model API to send health-status checks the vendor APIs as described above with reference to FIGS. 1A-1C and FIG. 6.

Receiving health-status responses from vendor APIs component 1124 is configured to receive health-status responses that contain the status codes of the deployments in the computing platform s as described above with reference to FIGS. 1A-1C and FIG. 6.

Executing weighted round-robin scheduling to distributed requests component 1126 is configured to perform weighted round-robin scheduling of requests as described above with reference to FIGS. 2A-2B.

Sending event-status reports to users component 1128 is configured to execute the event client and event email to send event-status reports to users as described above with reference to FIGS. 5-6.

### Example Clauses

Implementation examples are described in the following numbered clauses:

Clause 1: A computer-implemented method, comprising: periodically sending health-status checks to a vendor application programming interface (API); obtaining as output from the vendor API a health-status response identifying an available AI model; sending a request obtained from a user to the available AI model that corresponds to an AI model type identified in the request and is within a rate limit associated with the available AI model; and sending an answer generated by the available AI model to the user.

Clause 2: The method of Clause 1, further comprising: fetching current instances of the AI models in a group of AI models from an AI models database; and identifying available AI models in the group of AI models, type of AI models in the group of AI models, geographical region of the group of AI models, and vendor of the group of AI models.

Clause 3: The method of any one of Clauses 1-2, wherein periodically sending the health-status check to the vendor API comprises sending a health-status check to the vendor API at regular intervals.

Clause 4: The method of any one of Clauses 1-3, wherein obtaining as output from the vendor API the health-status response identifying the available AI model comprises: receiving the health-status response from the vendor API, the health-status response identifies each AI model in a group of AI models as an available AI model if the AI model is active or an unavailable AI model if the AI model not active; updating an AI model health status data store with information identifying available AI models and unavailable AI models based on the health-status response; and automatically sending an event-status report to stakeholders, the event-status report identifying the available AI models and the unavailable AI models in the group of AI models.

Clause 5: The method of any one of Clauses 1-4, further comprising: for each respective unavailable AI model of the group of AI models: sending health-status checks to the vendor API at shortened intervals until the vendor API sends a health-status response that identifies the respective unavailable AI model as an available AI model, wherein the shortened intervals have a shorter duration than regular intervals between health-status checks.

Clause 6: The method of any one of Clauses 1-5, wherein sending the request to the available AI model comprises: sending the request to an available AI model according to a weighted round-robin schedule of available AI models that correspond to the AI model type requested by the user, wherein weights in the weighted round-robin schedule are proportional to rate limits of the available AI models that correspond to the AI model types requested by the user

Clause 7: A processing system, comprising: a memory comprising computer-executable instructions; and a processor configured to execute the computer-executable instructions and cause the processing system to perform a method in accordance with any one of Clauses 1-6.

Clause 8: A processing system, comprising means for performing a method in accordance with any one of Clauses 1-6.

Clause 9: A non-transitory computer-readable medium storing program code for causing a processing system to perform the steps of any one of Clauses 1-6.

Clause 10: A computer program product embodied on a computer-readable storage medium comprising code for performing a method in accordance with any one of Clauses 1-6.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
periodically sending health-status checks to a vendor application programming interface (API);
obtaining as output from the vendor API a health-status response identifying an available AI model;
sending a request obtained from a client to the available AI model that corresponds to an AI model type identified in the request and is within a rate limit associated with the available AI model; and
sending an answer generated by the available AI model to the client.

2. The method of claim 1, further comprising:
fetching current instances of the AI models in a group of AI models from an AI models database; and
identifying available AI models in the group of AI models, type of AI models in the group of AI models, geographical region of the group of AI models, and vendor of the group of AI models.

3. The method of claim 1, wherein periodically sending the health-status check to the vendor API comprises sending a health-status check to the vendor API at regular intervals.

4. The method of claim 1, wherein obtaining as output from the vendor API the health-status response identifying the available AI model comprises:
receiving the health-status response from the vendor API, the health-status response identifies each AI model in a group of AI models as an available AI model if the AI model is active or an unavailable AI model if the AI model not active;
updating an AI model health status data store with information identifying available AI models and unavailable AI models based on the health-status response; and
automatically sending an event-status report to stakeholders, the event-status report identifying the available AI models and the unavailable AI models in the group of AI models.

5. The method of claim 4, further comprising:
for each respective unavailable AI model of the group of AI models:
sending health-status checks to the vendor API at shortened intervals until the vendor API sends a health-status response that identifies the respective unavailable AI model as an available AI model,
wherein the shortened intervals have a shorter duration than regular intervals between health-status checks.

6. The method of claim 1, wherein sending the request to the available AI model comprises:
sending the request to an available AI model according to a weighted round-robin schedule of available AI models that correspond to the AI model type identified in the request, wherein weights in the weighted round-robin schedule are proportional to rate limits of the available AI models that correspond to the AI model types identified in the request.

7. A processing system, comprising:
one or more memories comprising computer-executable instructions; and
one or more processors configured to execute the computer-executable instructions and cause the processing system to:
periodically send health-status checks to a vendor application programming interface (API);
obtain as output from the vendor API a health-status response identifying an available AI model;
send a request obtained from a client to the available AI model that corresponds to an AI model type identified in the request and is within a rate limit associated with the available AI model; and
send an answer generated by the available AI model to the client.

8. The processing system of claim 7, wherein the one or more processors are further configured to:
fetch current instances of the AI models in a group of AI models from an AI models database; and
identify available AI models in the group of AI models, type of AI models in the group of AI models, geographical region of the group of AI models, and vendor of the group of AI models.

9. The processing system of claim 7, wherein to periodically send the health-status check to the vendor API, the one or more processors are configured to cause the processing system to send a health-status check to the vendor API at regular intervals.

10. The processing system of claim 7, wherein to obtain as output from the vendor API the health-status response identifying the available AI model, the one or more processors are configured to cause the processing system to:
receive the health-status response from the vendor API, the health-status response identifies each AI model in a group of AI models as an available AI model if the AI model is active or an unavailable AI model if the AI model not active;
update an AI model health status data store with information identifying available AI models and unavailable AI models based on the health-status response; and
automatically send an event-status report to stakeholders, the event-status report identifying the available AI models and the unavailable AI models in the group of AI models.

11. The processing system of claim 10, wherein the one or more processors are further configured to:
for each respective unavailable AI model of the group of AI models:
send health-status checks to the vendor API at shortened intervals until the vendor API sends a health-status response that identifies the respective unavailable AI model as an available AI model,
wherein the shortened intervals have a shorter duration than regular intervals between health-status checks.

12. The processing system of claim 7, wherein to send the request to the available AI model, the one or more processors are configured to:
send the request to an available AI model according to a weighted round-robin schedule of available AI models that correspond to the AI model type identified in the request, wherein weights in the weighted round-robin schedule are proportional to rate limits of the available AI models that correspond to the AI model types identified in the request.

13. An apparatus comprising:
a scheduler application programming interface (API) configured to periodically identify available artificial intelligence (AI) models and unavailable AI models in a group of AI models; and
an AI model API configured to:
receive requests to use particular AI model types sent from a plurality of clients;
distribute the requests to the available AI models that correspond to the AI model types requested by the clients and are within rate limits of the available AI models; and
send answers generated by the available AI models to the plurality of clients in response to the requests.

14. The apparatus of claim 13, wherein the scheduler API comprises:
a time tick processor configured to get current status of the AI models; and
a check endpoint processor configured to send health-status checks to vendor APIs in regular intervals, each vendor API performs a health-status of corresponding AI models.

15. The apparatus of claim 13, wherein the scheduler API is configured to:
periodically send a health-status check to vendor APIs;
receive a health-status response from the vendor APIs identifying the available AI models and the unavailable AI models;
update an AI model health status data store with information identifying the available AI models and the unavailable AI models; and
automatically send event-status reports via email to stakeholders, each event-status report identifying the available AI models and the unavailable AI models.

16. The apparatus of claim 13, wherein the scheduler API is configured to send an AI model status report that identifies the available AI models and unavailable AI models to an AI interface API following each health-status check for the available AI models and the unavailable AI models.

17. The apparatus of claim 13, wherein the scheduler API is configured to, for each of the unavailable AI models, send health-status checks to a vendor API of a respective unavailable AI model at shortened intervals until the respective unavailable AI model is identified as an available AI model by the vendor API.

18. The apparatus of claim 13, wherein the scheduler API is configured to send an event-status report via email to stakeholders, the event-status report identifying the available AI models and the unavailable AI models.

19. The apparatus of claim 13, wherein:
the AI model API comprises a load balancer configured to distribute the requests to the available AI models according to a weighted round-robin schedule, and
weights of the weighted round-robin schedule are proportional to rate limits of the available AI models that correspond to the AI model types identified in the requests.

20. The apparatus of claim 19, wherein the load balancer is configured to:
send a largest number of requests to an available AI model with a largest corresponding rate limit, and
send a smallest number of prompts to an available AI model with a smallest corresponding rate limit.
